(19) United States
(12) Patent Application Publication
(10) Pub. No.: US 2003/0047455 A1
(43) Pub. Date: Mar. 13, 2003

(54) Separation of components from milk sources

(75) Inventors: Lucy Jane Ryan, Castle Hill (AU); Stewart Andrew Smith, Enfield (AU); Elizabeth Jean Seabrook, Lane Cove (AU); Philip John Roeth, Castle Hill (AU)

Correspondence Address: BAKER & MCKENZIE, 805 THIRD AVENUE, NEW YORK, NY, 10022, US

(73) Assignee: Gradipore Limited, Frenchs Forest NSW (AU)

(21) Appl. No.: 10/212,974

(22) Filed: Aug. 6, 2002

(30) Foreign Application Priority Data
Aug. 6, 2001 (AU) PR6835
Feb. 12, 2002 (AU) PS0503

(51) Int. Cl. G01L 1/20

(52) U.S. Cl. 204/540; 204/543

(57) ABSTRACT

The claims describe methods and apparatus for obtaining a target component from a milk source using a membrane-based electrophoresis separation system. They may also be used in conjunction with or as a substitute for one or more steps in a conventional purification scheme for obtaining target component from a milk source.

A milk source is pre-treated to remove or reduce the concentration of fats, casein, protein, or a combination thereof. Using an electrophoresis apparatus containing a separation membrane to define a first and second interstitial volume between at least two restriction membranes, the pre-treated milk source is placed in one of the interstitial volumes. A solvent maintains the target component in the milk source in a desired charge state. Applying a potential between the first and second interstitial volumes separates at least a portion of the target component on one side of the separation membrane from unwanted molecules on the other side of the separation membrane.

### CROSS-REFERENCE TO RELATED APPLICATIONS

The present application claims benefit of Australian application No. PR 6835 filed Aug. 6, 2001 and Australian application No. PS0503 dated Feb. 12, 2002.

### FIELD

The present application relates to methods and apparatus for obtaining one or more target components from a milk source using a membrane-based electrophoresis system.

### BACKGROUND

Membrane-based electrophoresis technology currently has the ability to extract proteins from plasma, (as well as cryosupematant, cryoprecipitate, and different Cohn fractions). Furthermore, this technology has the capability to remove viruses and other infectious agents from biological materials. Membrane-based electrophoresis has been used for the separation of micromolecules (molecules determined to be less than 5 kDa in size) and has been shown to have the capabilities to be used in renal dialysis.

One milk source of interest is colostrum. Colostrum is a thick, yellow substance that is produced toward the end of a mammal's pregnancy and is expressed by the mammary glands during the first 48 hours after giving birth. Its contents include immunoglobulins, fats, growth factors, antibodies, vitamins, minerals, enzymes, amino acids. Many of these compounds are of a commercial interest in both their native and purified states.

Attempts have been made to develop methods for obtaining immunoglobulins from colostrum using a number of separation techniques such as ion-exchange chromatography. For example, U.S. Pat. No. 4,582,580 (Fromageries Bel) relates to the use of liquid electrophoresis to fractionate colostrum to obtain an immunoglobulin-rich fraction, which is then processed by ion-exchange chromatography to purify the immunoglobulins. The process is based on methods employed to fractionate immunoglobulins from plasma. The liquid electrophoresis system employs ion-exchange cellophane membranes that allow increased ion-exchange under an electrical field. Electrophoresis separates colostrum into two fractions which then are processed by another separation method to obtain immunoglobulins.

Proteins are currently extracted from milk sources for food and nutriceutical purposes, as well as research into the pharmaceutical market. Applications include enriching modified milk with additional protein, use of milk protein in chocolate and other food products, producing enriched protein supplements for the sporting and neutraceutical markets. Currently, the extraction of protein from milk can be performed by precipitation, filtration and chromatographic methods.

The extraction of recombinant proteins from the milk of transgenic animals has also arisen as a new industrial purification area. These proteins are usually produced and extracted for therapeutic purposes. Examples of animals used to produce recombinant proteins in milk include cows that produce fibrinogen, goats that produce monoclonal antibodies, and sheep that produce alpha-1-proteinase inhibitor (α-1-PI). Other animals have also been engineered to produce human proteins, including rabbits, mice and pigs. Suitable transgenic animals produce a substantial volume of milk.

Due to the nature of milk being viscous, proteinaceous and having high fat and lipid content, membrane-based electrophoresis is currently not considered a suitable technique for commercial processing of milk sources.

### SUMMARY

The present application relates to various methods and apparatus for obtaining a target component from a milk source using a membrane-based electrophoresis separation system.

In one aspect, a method pre-treats the milk source to remove or reduce the concentration of fats, casein, protein, or a combination thereof. Using an electrophoresis apparatus containing a separation membrane to define a first and second interstitial volume between at least two restriction membranes, the pre-treated milk source is placed in one of the interstitial volumes. A selected solvent maintains the target component in the milk source in a desired charge state. Applying a potential between the first and second interstitial volumes separates at least a portion of the target component on one side of the separation membrane from unwanted molecules on the other side of the separation membrane.

In another aspect, an apparatus contains a first interstitial volume between a first restriction membrane and a separation membrane, and a second interstitial volume between a second restriction membrane and the separation membrane. A transporter connected to at least one of the interstitial volumes carries milk source to either or both the interstitial volumes. An electric potential applied to the apparatus separates at least a portion of a target component on one side of the separation membrane while unwanted molecules are located on the other side of the separation membrane.

These and other features of the claims will be appreciated from review of the following detailed description of the application along with the accompanying figures.

### BRIEF DESCRIPTION OF THE DRAWINGS

FIG. 1 is a block diagram of a method for obtaining a target component from a milk source using a membrane-based electrophoresis separation system;

FIG. 2 shows a 4-20% SDS-PAGE gel for the purification of spiked albumin from milk which has been pre-treated by precipitation. Lanes 4-7 denote the albumin product, harvested every 60 minutes. Lane 1: MW marker, lane 2: starting material in S1 (milk whey with albumin spike), lane 3: residual S1 sample, lane 4: S2 0 minutes, lane 5: S2 60 minutes, lane 6: S2 120 minutes, lane 7: S2 180 minutes;

FIG. 3 shows a 4-20% SDS-PAGE gel for the purification of spiked α-1-PI from milk which has been pre-treated by precipitation. Lanes 4-9 denote the α-1-PI product, harvested every 60 minutes, while lane 10 is the α-1-PI product harvested at 420 minutes. Lane 1: MW marker, lane 2: starting material in S1 (milk whey with α-1-PI spike), lane 3: residual S1 sample, lane 4: S2 0 minutes, lane 5: S2 60 minutes, lane 6: S2 120 minutes, lane 7: S2 180 minutes, lane 8: S2 240 minutes, lane 9: S2 300 minutes, lane 10: S2 420 minutes;

FIG. 4 shows a 4-20% SDS-PAGE gel for the purification of spiked α-1-PI from milk which has been pre-treated by dilution. Lanes 4-7 denote the α-1-PI product, harvested every 60 minutes. Lane 1: MW marker, lane 2: starting material in S1 (milk with α-1-PI spike), lane 3: residual S1 sample, lane 4: S2 0 minutes, lane 5: S2 120 minutes, lane 6: S2 240 minutes, lane 7: S2 360 minutes, lane 8: Prolastin (1 mg/mL), lane 9: Prolastin (0.5 mg/mL);

FIG. 5 shows a 4-20% SDS-PAGE gel for the purification of spiked fibrinogen from milk that has been pre-treated by rennet coagulation. Lane 6 denotes the fibrinogen product, harvested at 180 minutes. Lane 1: MW marker, lane 2: fibrinogen standard (1 mg/mL), lane 3: starting material in S1 (milk with fibrinogen spike), lane 4: residual S1 sample, lane 5: S2 0 minutes, lane 6: S2 180 minutes;

FIG. 6 shows a graph comparing the recoveries of α-1-PI, albumin and fibrinogen retained in milk whey after different pre-treatments of skim milk to remove casein. The percentage of protein retained in the whey fraction after the various pre-treatments show the success of each pre-treatment for each protein;

FIG. 7 shows a graph comparing the retention of spiked albumin in milk whey after different pre-treatments. The percentage of albumin retained after the pre-treatment shows the success of each pre-treatment;

FIG. 8 shows an IEF gel of milk whey proteins treated with EDTA. Lane 1: pI marker; Lane 2: milk whey treated with EDTA (4:1 dilution, 250 mM, pH 7.0);

FIG. 9 shows a 4-20% SDS-PAGE gel for a high/low molecular weight split of milk whey with EDTA pre-treatment at pH 8.0. Lane 3 is the resulting high molecular weight fraction, while, lanes 4-10 are the resulting low molecular weight fraction. Lane 1: MW marker, lane 2: starting material in S1(milk whey), lane 3: residual S1 sample (high molecular weight fraction), lane 4: S2 30 minutes, lane 5: S2 60 minutes, lane 6: S2 90 minutes, lane 7: S2 120 minutes, lane 8: S2 150 minutes, lane 9: S2 180 minutes, lane 10: S2 210 minutes;

FIG. 10 shows a 4-20% SDS-PAGE gel for the processing of a high molecular weight fraction derived from milk whey. Lanes 4-9 denote the harvest material, largely containing IgG. Lane 1: MW marker, lane 2: starting material in S2(high molecular weight fraction derived from whey), lane 3: residual S2 material, lane 4: S1 30 minutes, lane 5: S1 60 minutes, lane 6: S1 90 minutes, lane 7: S1 120 minutes, lane 8: S1 150 minutes, lane 9: S1 180 minutes, lane 10: lactoferrin control (lane 4-9 ; IgG harvests);

FIG. 11 shows a 4-20% SDS-PAGE gel for the purification of IgG from a commercially available colostrum preparation (Intact™). Lanes 4-10 denote the IgG product, harvested every 30 minutes. Lane 1: MW marker, lane 2: starting material in S1, lane 3: residual S1 sample, lane 4: S2 0 minutes, lane 5: S2 30 minutes, lane 6: S2 60 minutes, lane 7: S2 90 minutes, lane 8: S2 120 minutes, lane 9: S2 150 minutes, lane 10: S2 180 minutes;

FIG. 12 shows a schematic of a modification of an electrophoresis apparatus suitable for obtaining a target component from milk source;

FIG. 13 shows a schematic of a further modification of an electrophoresis apparatus suitable for obtaining a target component from milk source;

FIG. 14 shows an SDS-PAGE gel for the purification of IgG from a commercially available colostrum preparation (Intact™) with no EDTA pre-treatment at pH 5.0. Lanes 3-8 denote the IgG product, harvested every 30 minutes. Lane 1: MW marker, lane 2: starting material in S1 (colostrum preparation), lane 3: S2 30 minutes, lane 4: S2 60 minutes, lane 5: S2 90 minutes, lane 6: S2 120 minutes, lane 7: S2 150 minutes, lane 8: S2 180 minutes, lane 9: S2 pooled, lane 10: residual S1 sample;

FIG. 15 shows an SDS-PAGE gel for the purification of IgG from a commercially available colostrum preparation (Intact™) with EDTA pre-treatment at pH 5.0. Lanes 5-10 denote the IgG product, harvested every 30 minutes. Lane 1: MW marker, lane 2: colostrum preparation (Intact™), lane 3: starting material in S2, lane 4: residual S2 sample, lane 5: S1 30 minutes, lane 6: S1 60 minutes, lane 7: S1 90 minutes, lane 8: S1 120 minutes, lane 9: S1 150 minutes, lane 10: S1 180 minutes;

FIG. 16 shows an SDS-PAGE gel for the purification of IgG from colostrum whey derived from a commercially available colostrum preparation (Intact™) with EDTA pre-treatment at pH4.6. Lane 4-8 denotes the IgG product, harvested every 60 minutes. Lane 1: MW marker, lane 2: starting material in S2 (Intact™ whey), lane 3: residual S2 sample, lane 4: S1 60 minutes, lane 5: S1 120 minutes, lane 6: S1 180 minutes, lane 7: S1 240 minutes, lane 8: S1 300 minutes, lane 10: no sample, lane 9: no sample;

FIG. 17 is an SDS-PAGE gel for protein movement from fresh colostrum at pH 5.0. Lane 1: MW marker, lane 2: starting material in S2 (fresh colostrum), lane 3: S1 30 minutes, lane 4: S1 60 minutes, lane 5: S1 90 minutes, lane 6: S1 120 minutes, lane 7: S2 30 minutes, lane 8: S2 60 minutes, lane 9: S2 90 minutes, lane 10: S2 120 minutes;

FIG. 18 is an SDS-PAGE gel for protein movement from fresh colostrum at pH 6.0. Lane 1: MW marker, lane 2: starting material in S2 (fresh colostrum), lane 3: S1 30 minutes, lane 4: S1 60 minutes, lane 5: S1 90 minutes, lane 6: S1 120 minutes, lane 7: S2 30 minutes, lane 8: S2 60 minutes, lane 9: S2 90 minutes, lane 10: S2 120 minutes;

FIG. 19 is an SDS-PAGE gel for protein movement from fresh colostrum at pH 7.0. Lane 1: MW marker, lane 2: starting material in S1 (fresh colostrum), lane 3: S1 30 minutes, lane 4: S1 60 minutes, lane 5: S1 90 minutes, lane 6: S1 120 minutes, lane 7: S2 30 minutes, lane 8: S2 60 minutes, lane 9: S2 90 minutes, lane 10: S2 120 minutes;

FIG. 20 is an SDS-PAGE gel for protein movement from fresh colostrum at pH 8.0. Lane 1: MW marker, lane 2: starting material in S1 (fresh colostrum), lane 3: S1 30 minutes, lane 4: S1 60 minutes, lane 5: S1 90 minutes, lane 6: S1 120 minutes, lane 7: S2 30 minutes, lane 8: S2 60 minutes, lane 9: S2 90 minutes, lane 10: S2 120 minutes;

FIG. 21 is an SDS-PAGE gel for protein movement from fresh colostrum at pH 9.0. Lane 1: MW marker, lane 2: starting material in S1 (fresh colostrum), lane 3: S1 30 minutes, lane 4: S1 60 minutes, lane 5: S1 90 minutes, lane 6: S1 120 minutes, lane 7: S2 30 minutes, lane 8: S2 60 minutes, lane 9: S2 90 minutes, lane 10: S2 120 minutes;

FIG. 22 is an SDS-PAGE gel for protein movement from fresh colostrum at pH 10.0. Lane 1: MW marker, lane 2: starting material in S1 (fresh colostrum), lane 3: S1 30 minutes, lane 4: S1 60 minutes, lane 5: S1 90 minutes, lane 6: S1 120 minutes, lane 7: S2 30 minutes, lane 8: S2 60 minutes, lane 9: S2 90 minutes, lane 10: S2 120 minutes;

FIG. 23 shows an SDS-PAGE gel for the purification of IgG from fresh colostrum whey at 60× scale up separation. Lane 7-10 denotes the IgG product, harvested every 60 minutes. Lane 1: MW marker, lane 2: starting material in S1 (fresh colostrum whey), lane 3: S1 60 minutes, lane 4: S1 120 minutes, lane 5: S1 180 minutes, lane 6: S1 240 minutes, lane 7: S2 60 minutes, lane 8: S2 120 minutes, lane 9: S2 180 minutes, lane 10: S2 240 minutes; and

FIG. 24 shows the average total protein transfer across the separation membrane for 50 non-consecutive hours of processing colostrum whey. At the fifth day (50 hours) the membranes reached their half life in performance under the chosen conditions.

### DETAILED DESCRIPTION

Embodiments for separating a target component from a milk source using a membrane-based electrophoresis separation system according to the present claims are described in non-limiting detail below. These embodiments may also be used to separate toxin, pathogen or infectious agent contamination from a milk source component, and in substitution or conjunction with one or more steps in a conventional purification scheme for the separation of a target component from a milk source.

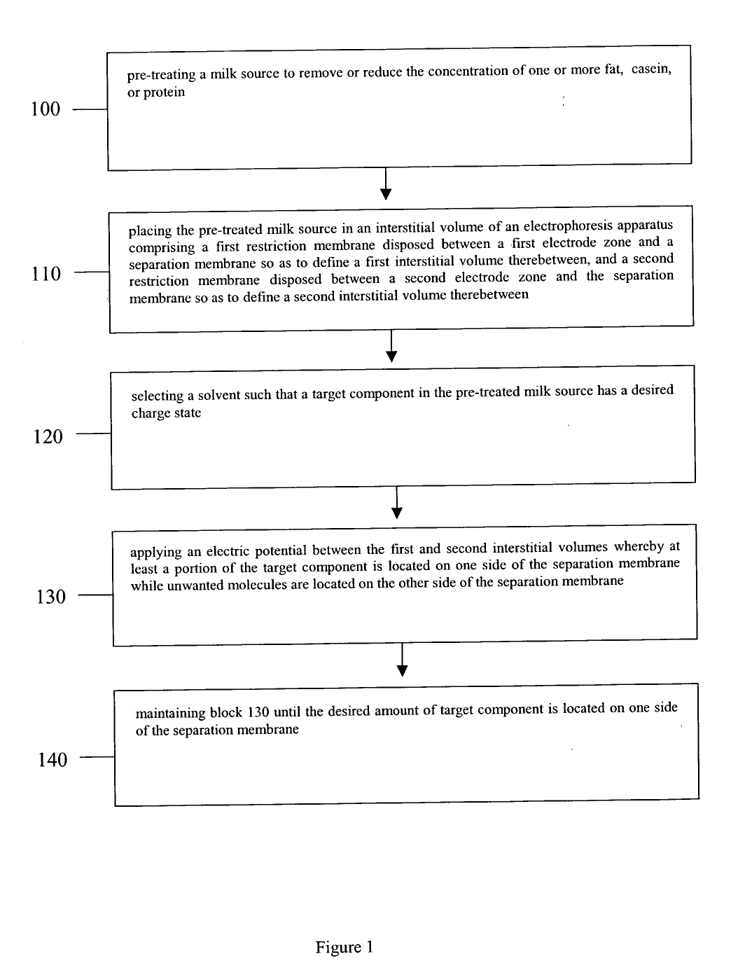

FIG. 1 refers to a block diagram of a method of obtaining a target component from a milk source in accordance with one aspect of the present claims. In one embodiment, the milk source may be milk, whey, casein, colostrum, or one or more components or combinations thereof. The milk source or milk components may be obtained from a normal animal, a hyperimmunised animal, a transgenic animal, or a genetically altered animal. A transgenic animal produces recombinant proteins or peptides as a result of genetic modification of the lactating species. For example, suitable milk sources may be derived from transgenic cows, sheep, goats, rabbits, pigs, mice or other lactating mammalian species. However, other known milk sources that may be adapted to membrane-based electrophoresis may also be used. Some of these milk sources may contain toxins, pathogens, infectious agent contaminants or other unwanted molecules in the milk source. For example, endotoxins, prions, viruses, bacteria, fungi, yeasts, protozoa, or other unwanted molecules may contaminate a milk source.

Block 100 depicts pre-treating the milk source to remove or reduce the concentration of one or more fats, casein, or protein. Without being limited by any theory, pre-treatment can decrease protein-protein interactions in the milk source that may hinder electrophoretic separation. Pre-treatment steps such as dilution, centrifugation, precipitation, filtration, de-fatting, detergent addition, chelation, acidification, fat-disrupting agent addition, coagulation, protein denaturing agent addition, enzymatic breakdown or hydrolysis may be used. However, other suitable pre-treatment steps that reduce the concentration of fats, casein or protein are known in the art and may be used.

In one embodiment, rennet (chymosin) is used in a coagulation step. Rennet (e.g., a proteolytic enzyme found in the stomach of calves) is used to coagulate milk by causing casein to aggregate. Coagulated milk is centrifuged to separate the coagulate from the supernatant (referred to as the ‘whey fraction’), which contains substantially all the soluble proteins. Generally, the whey fraction contains the targeted protein components from milk. After centrifugation, the whey is filtered to remove any particulate matter that is present. After filtration, the whey is used for target protein component extraction in the electrophoresis system. Dilution of the milk or whey fraction to an appropriate level allows for filtering using a particle filter which retains the larger fat globules and casein micelles and allows soluble target protein components to pass through and be collected in a substantially particle-free state. Other fat-decreasing processes are known and are also suitable as a pre-treatment step.

Another embodiment uses a centrifugation step to reduce solids by precipitating casein out of solution. Periodic draining and remote centrifugation, or in-line centrifugation are representative but non-limiting examples of suitable centrifugation steps. Other centrifugation methods known in the art may also be used. For example, existing in-line centrifugation technology is used in preparation of skim milk and whole blood aphaeresis procedures, and may be used according to the present claims.

In another embodiment, ethylene diaminetetraacetic acid (EDTA) is a representative chelating agent that may be used in a chelating step. Without being limited by any theory, EDTA assists in removing the calcium core of casein micelles and facilitates the reduction of protein-protein interactions found in milk sources.

Other embodiments utilize detergents (ionic or non-ionic) such as Tween-20™ or CHAPS™, organic solvents that disrupt fat/colloid structure, enzyme treatments, as well as denaturing agents such as urea to decrease the colloids in the milk source. Other pre-treatment steps that reduce, remove or disrupt fat or casein content, or protein-protein interactions are readily known in the art and may be used as pre-treatment steps. In one embodiment, acidification involves hydrochloric acid or acetate. However, other acidifying mechanisms known in the art may also be used.

Block 110 places the pre-treated milk source in an interstitial volume of an electrophoresis apparatus. A suitable electrophoresis apparatus contains a separation membrane. The molecular mass cut off of the separation membrane is different from the molecular mass cut off of a target component in the milk source. For example, the molecular mass cut off may be greater than the molecular mass of the target component or the cut off may be lower than the molecular mass of the target component. Those skilled in the art will appreciate that molecular mass cut offs may also be determined depending on the molecular masses of other molecules in the sample, such as contaminants, salts, or stabilizing agents. The pore sizes of the membranes are selected on the basis of size exclusion. In one embodiment, the separation membrane is comprised of polyacrylamide. It will be appreciated, however, that other membrane chemistries or constituents can be used.

The separation membrane is located in an electric field area and selection of a suitable solvent may depend on the pI value of a target component. In one embodiment, the pH value of the solvent is selected to be different from the pI value of the target component. For example, the pH value of the solvent may be higher than the pI value of the target component. Alternatively, the pH value of the solvent may be lower than the pI value of the target component. The selection of a suitable solvent based on the pI value of the target component is readily ascertainable by the skilled practitioner.

In one embodiment, a first restriction membrane disposed between a first electrode zone and the separation membrane defines a first interstitial volume therebetween. A second restriction membrane disposed between a second electrode zone and the separation membrane defines a second interstitial volume therebetween. For convenience only, the first interstitial volume or stream is called stream 1 (S1) and the second interstitial volume or stream is called stream 2 (S2).

In one embodiment, the restriction membranes forming the first and second interstitial volumes are provided as a cartridge or cassette positioned between the electrode zones of the apparatus. In another embodiment, the configuration of the cartridge is a housing with the separation membrane positioned between the first and second restriction membranes thus forming the required interstitial volumes. In some embodiments, the cartridge or cassette is removable from an electrophoresis apparatus adapted to contain or receive the cartridge. Other membrane configurations containing a separation membrane and restriction membranes to form the interstitial volumes are also contemplated by the present claims.

In one embodiment, the first and second restriction membranes are formed from polyacrylamide. However, other membrane chemistries may be used to form suitable restriction membranes and are known in the art. Typically, the restriction membranes have molecular mass cut offs different from the separation membrane. In some embodiments, the restriction membranes have molecular mass cut off between 1 kDa to about 1000 kDa. However, other mass cut offs may be used. As with the separation membrane, the pore sizes of the restriction membranes are selected on the basis of size exclusion. The selection of the molecular mass cut off of the restriction membranes will depend on the sample being processed and the size of the macromolecules to be removed. The first and second restriction membranes may have the same molecular mass cut off or different cut offs, forming an asymmetrical arrangement.

In one suitable apparatus, the electrode zones and the interstitial volumes are configured to allow flow of the respective fluid/buffer and sample solutions forming streams. In this form, large volumes can be processed quickly and efficiently. The solutions are typically moved or recirculated through the electrode zones and interstitial volumes from respective reservoirs by suitable pumping means. For example, peristaltic pumps may be used as the pumping means for moving the sample, buffers or fluids.

In another suitable apparatus, a heat removing arrangement removes heat generated in the electrophoresis apparatus. For example, samples and fluids are passed through heat exchangers to remove heat produced by the apparatus during electrophoresis. As another example, electrode buffer, other buffers, and sample solutions are cooled by any suitable arrangement to limit inactivation of compounds during the separation process and to maintain a desired temperature of the apparatus while in use.

In a suitable electrophoresis apparatus, the distance between the electrodes has an effect on the separation or movement of sample constituents through the membranes. The shorter the distance between the electrodes, the faster the electrophoretic movement of constituents. A distance of about 6 mm has been found to be suitable for a laboratory scale apparatus. For scale-up versions, the distance will depend on the number and type of separation membranes, the size and volume of the chambers for samples, buffers and separated products. Preferred distances would be in the order of about 6 mm to about 10 cm. The distance will also relate to the voltage applied to the apparatus.

The effect of the electric field is based on the equation:

e=V/d

(e=electric field, V=voltage, d=distance)

Therefore, the smaller the distance between the electrodes the faster the separation. Preferably, the distance between the electrodes should decrease in order to increase electric field strength, thereby further improving transfer rates through the membranes.

In this embodiment, the first electrode is preferably the cathode and the second electrode is preferably the anode. Depending on the milk source to be treated and the pH of the solvents or buffers used, the configuration can be reversed where the first electrode is the anode and the second electrode is the cathode.

Flow rate of sample/buffer/fluid has an influence on the separation of constituents. Rates of milliliters per minute up to liters per hour can be used depending on the configuration of the apparatus and the target component to be separated. For example, in one laboratory scale instrument, the preferred flow rate is about 20±5 mL/min. However, flow rates from near 0 mL/min to about 50,000 mL/min have also been used across various separation regimes. The maximum flow rate is even higher, depending on the pumping means and size of the apparatus. Other flow rates may also may be used. The selection of the flow rate is dependent on the product to be transferred, efficiency of transfer, pre- and post-positioning with other applications, and is readily ascertainable by one skilled in the art.

Selection or application of the voltage and/or current applied varies depending on the separation. Typically up to several thousand volts are used but choice and variation of voltage will depend on the configuration of the apparatus, buffers and the sample to be separated. In a laboratory scale instrument, the preferred voltage is about 250 V. However, depending on transfer, efficiency, scale-up and particular method, near 0 V to 5000 V are used. Higher voltages may be used, depending on the apparatus and sample to be treated. Selection of a suitable voltage is readily ascertainable by practitioners skilled in the art.

Optionally, the electric potential may be periodically stopped and reversed to cause movement of a constituent or unwanted molecule having entered a membrane to move back into the volume or stream from which it came, while substantially not causing any target component that has passed completely through a membrane to pass back through the membrane.

Reversal of the electric potential is an option but another alternative is a resting period. Resting (a period without an electric potential being applied) is an optional step that can replace or be included before or after an optional electrical potential reversal. This resting technique often can be practiced for specific separation applications as an alternative or adjunct to reversing the potential.

In another suitable apparatus and method, solution in at least one of the interstitial volumes or streams containing any separated compounds or molecules is collected and replaced with suitable solvent to ensure that electrophoresis continues efficiently. Suitable apparatus may also be adapted to accommodate large volume through-put as well as different separation configurations.

One suitable apparatus contains a cathode in a cathode zone, an anode in an anode zone, the anode disposed relative to the cathode so as to be adapted to generate an electric field in an electric field area therebetween upon application of an electric potential between the cathode and the anode, a first restriction membrane disposed between a first electrode zone and a separation membrane so as to define a first interstitial volume therebetween, a second restriction membrane disposed between a second electrode zone and the separation membrane so as to define a second interstitial volume therebetween, and a transporter that provides pre-treated milk source to a selected one of the first interstitial and second interstitial volumes. Application of the electric potential removes at least a portion of a target component from the milk source through at least one membrane and provided to the other of the first and second interstitial volumes or the cathode or anode zones. In one embodiment, the cathode zone, anode zone, and the interstitial volumes are supplied with suitable solvent or buffer solutions by a solvent structure. One embodiment of a solvent structure includes a pumping means, such as a peristaltic pump. Practitioners skilled in the art will appreciate that other pumping means and other solvent structures that are capable of delivering solvent to the interstitial volumes and electrode zones are known and may also be used.

In another embodiment, the electrophoresis apparatus contains a first restriction membrane disposed between a first electrode zone and a separation membrane so as to define a first interstitial volume therebetween. A second restriction membrane disposed between a second electrode zone and the separation membrane defines a second interstitial volume therebetween. A transporter connected to at least one of the first or second interstitial volumes delivers milk source reduced in fat, casein, or protein to at least one of the first or second interstitial volumes. Upon application of an electric potential, target component is located on one side of the separation membrane while unwanted molecules are located on the other side of the separation membrane.

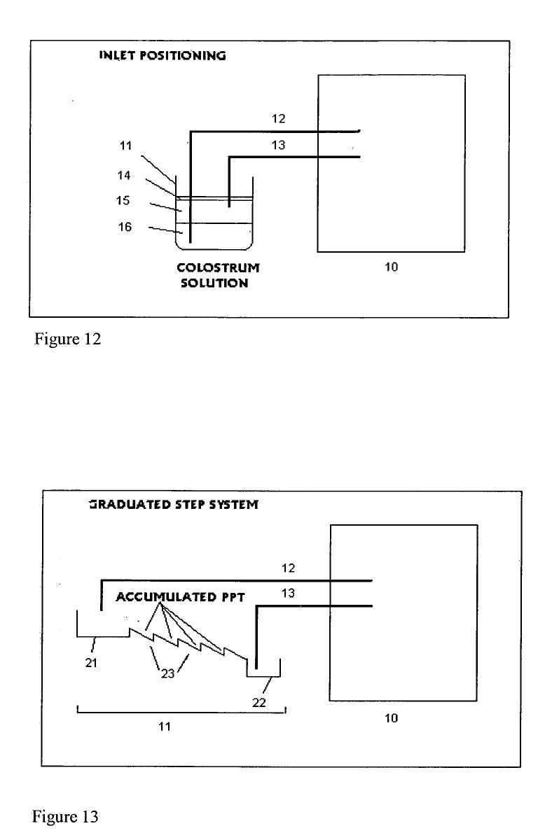

In another suitable apparatus, the transporter delivers the pre-treated milk source to the first or second interstitial volumes by any suitable pumping means. In one embodiment, the transporter comprises a settling reservoir containing the milk source, and allows for the processing of milk source in the reservoir without introducing extra fats or milk solids to the electrophoresis apparatus. The settling reservoir contains a milk source. The reservoir has an inlet to one of the first or second interstitial volumes for supplying the milk source, and an outlet from either the first or second interstitial volumes returning sample to the reservoir, wherein the inlet is positioned such that milk source is removed from the reservoir and passed to the first interstitial volume, whereas fats and solids in the milk source remain in the reservoir. For example, FIG. 12 illustrates one non-limiting example of a settling reservoir in which the inlet positioning of the first interstitial volume has been modified in an electrophoresis apparatus 10. Outlet 12 of first interstitial volume on apparatus 10 may be constructed from hose, tubing, or any other suitable solvent delivery source, with one end positioned on the bottom of beaker 11. Inlet 13 on apparatus 10 is also constructed from hose with one end positioned just below the surface of the sample in the beaker 11. When a milk source solution is processed, it can form into three layers 14, 15, 16. A fat layer 14 forms on the surface, a whey layer 15 forms under the fat layer 14, and precipitate forms under the whey layer 15 at the bottom of the beaker 11. The configuration in FIG. 12 allows for sampling from the whey layer 15 and return from the apparatus to the precipitate layer 16. This results in the solution being circulated in the first interstitial volume being taken from the most ‘clean’ area of the solution.

In another embodiment, the settling reservoir comprises an upper reservoir and a lower reservoir, the upper and lower reservoirs being in fluid communication and separated by a series of graduated steps capable of retaining solid material therein but allowing fluid to flow from the upper reservoir to the lower reservoir, the outlet being positioned in the upper reservoir and the inlet being positioned in the lower reservoir. As seen in FIG. 13, the settling reservoir acts as a graduated ‘sieve’. The first interstitial volume of reservoir 11 is formed by an upper reservoir 21 and a lower reservoir 22 separated by a series of graduated steps 23. Outlet 12 for the first interstitial volume on apparatus 10 was constructed from hose with one end positioned in the upper reservoir 21. Inlet 13 on apparatus 10 was also constructed of hose with one end positioned in the lower reservoir 22. The graduated steps 23 between the upper reservoir 21 and the lower reservoir 22 act to trap milk source precipitate as sample runs from the upper reservoir 21 to the lower reservoir 22. The first interstitial volume solution flows across the set of graduated steps 23 that capture the precipitated solids, allowing them to settle between the two reservoirs 21 and 22. The whey or other milk source component is not restricted and flows to lower reservoir 22 at the lower end of graduated steps 23. Intake for the first interstitial volume is then taken from this ‘clean’ solution in lower reservoir 22. Although the inlets and outlets were constructed of hose in this example, other solvent delivery sources, such as tubing are known in the art and may be used.

While the various electrophoresis apparatus described above may obtain a target component from a milk source according to the present claims, other membrane-based electrophoresis apparatus known in the art are also suitable and may be used, such as those described in U.S. application Ser. Nos. 09/961,591, 09/990,549, incorporated by reference herein

In FIG. 1, block 120 selects a solvent having a pH such that a target component in the pre-treated milk source has a desired charge state. Depending on the solvent, the target component is maintained in either a positive, negative, or neutral charge state. For example, selecting a buffer having a pH greater than the pI value of the target component maintains the component in a negatively charged state. Selecting a buffer having a pH lower than the pI value of the target component maintains the component in a positively charged state. A buffer having a pH equal to the pI value of the target component maintains the target component in a neutral charge state. The selection of an appropriate buffer to maintain a target component in a desired charge state is readily ascertainable to one skilled in the art.

Block 130 applies an electric potential between the first and second interstitial volumes whereby at least a portion of a target component is located on one side of the separation membrane while unwanted molecules are located on the other side of the separation membrane. More than one target compound may be isolated within a given separation. For example, two proteins may be extracted simultaneously from a milk source within a single separation.

Block 140 maintains the potential applied in block 130 until the desired amount of target component is located on one side of the separation membrane while unwanted molecules are located on the other side of the separation membrane. A desired amount of target component may be isolated and extracted before complete separation of any given sample is effected.

In one embodiment, the milk source is pre-treated to remove or reduce the concentration of one or more fats, casein, or protein. The pre-treated milk source is placed in a first interstitial volume of a suitable electrophoresis apparatus comprising a separation membrane, a first restriction membrane disposed between a first electrode zone and the separation membrane so as to define a first interstitial volume therebetween, and a second membrane disposed between a second electrode and the separation membrane so as to define a second interstitial volume therebetween. A solvent is selected for the first interstitial volume having a pH such that the component in the pre-treated milk source has a desired charge state. Applying an electric potential between the first and second interstitial volumes moves the target component in the first interstitial volume through the separation membrane into the second interstitial volume while unwanted molecules in the pre-treated milk source are prevented from entering the second interstitial volume. The electric potential is maintained until the desired amount of target component is moved to the second interstitial volume.

In another embodiment, target component may be obtained substantially free from toxin, pathogen or infectious agent contamination. For example, toxins, pathogens or infectious agents that may be removed are endotoxins, prions, viruses, bacteria, fungi, yeasts or protozoa. However, other toxin, pathogens or infectious agents may also be removed by a method practiced according to the present claims.

In one embodiment, the milk source (and toxin, pathogen, or infectious agent contaminants) is pretreated to remove or reduce the concentration of one or more fats, casein, or protein. The pre-treated milk source is placed in a first interstitial volume of a suitable electrophoresis apparatus comprising a separation membrane, a first restriction membrane disposed between a first electrode zone and the separation membrane so as to define a first interstitial volume therebetween, and a second restriction membrane disposed between a second electrode and the separation membrane so as to define a second interstitial volume therebetween. A solvent is selected for the first interstitial volume having a pH such that the target component in the pre-treated milk source has a desired charge state. Applying an electric potential between the first and second interstitial volumes moves the target component in the first interstitial volume through the separation membrane into the second interstitial volume while unwanted molecules, toxin, pathogen, or infectious agent contaminants are prevented from entering the second interstitial volume. The electric potential is maintained until the desired amount of target component is moved to the second interstitial volume. In another embodiment, both viral and bacterial contaminants are separated from the target component.

The methods and apparatus described herein are suitable for obtaining a large variety of target components from milk sources. For example, proteins, peptides, antibodies, growth factor, immunoglobulin, immunoglobulin G, lactalbumin, lactoglobulin, transgenically expressed recombinant proteins or peptides, recombinant forms thereof, and mixtures thereof are representative and non-limiting examples of components that may be obtained according to the present claims. Non-limiting examples of recombinant proteins include fibrinogen, albumin, antibodies, or insulin. Obviously, other target components selected by the skilled practitioner may also be obtained after suitable pre-treatment and membrane-based electrophoresis according to the present claims. The appropriate choice of membrane and buffer pH is based on the target component to be separated. For example, for whole milk applications, the pH of the buffer solution is usually restricted to above pH 4.6 because milk proteins tend to precipitate at lower pH levels. However, lower pH values may be used when whey is a starting material. Because of the high throughput nature of membrane-based electrophoresis, the claimed methods and apparatus are useful in commercial and industrial applications. For example, electrophoresis may be accomplished in a batch processing approach where the target component is extracted from a large volume of milk source in a primary capture or partial separation or purification mode. Either additional preparative electrophoresis or chromatographic means known in the art could perform further purification as required.

To assist in understanding the present application, the following examples are included and describe the results of a series of experiments. The following examples relating to this application should not be construed to specifically limit the application or such variations of the application, now known or later developed, which fall within the scope of the application as described and claimed herein.

In the following examples, the term “stream 1 (S1)” refers to the first interstitial volume. The term “stream 2 (S2)” refers to the second interstitial volume. The term “forward polarity” is used when the first electrode is the cathode and the second electrode is the anode in the electrophoresis apparatus and current is applied accordingly. The term “reverse polarity” is used when polarity of the electrodes is reversed such that the first electrode becomes the anode and the second electrode becomes the cathode. The term “buffer” is intended to include solutions of electrolytes. The buffer is a solution that conducts electricity. The buffer maintains to some extent a pH of its environment.

### Analytical Methods

Polyacrylamide Gel Electrophoresis (PAGE)

PAGE was used to measure the movement of components during an electrophoresis run. Standard PAGE methods were employed as set out below.

Reagents: 10×SDS Glycine running buffer (Gradipore Limited, Australia), dilute using Milli-Q water to 1× for use; 1×SDS Glycine running buffer (29 g Trizma base, 144 g Glycine, 10 g SDS, make up in RO water to 1.0 L); 10×TBE II running buffer (Gradipore), dilute using Milli-Q water to 1× for use; 1×TBE II running buffer (10.8 g Trizma base, 5.5 g Boric acid, 0.75 g EDTA, make up in RO water to 1.0 L); 2×SDS sample buffer (4.0 mL, 10% (w/v) SDS electrophoresis grade, 2.0 mL Glycerol, 1.0 mL 0.1% (w/v) Bromophenol blue, 2.5 mL 0.5M Tris-HCl, pH 6.8, make up in RO water up to 10 mL); 2×Native sample buffer (10% (v/v) 10×TBE II, 20% (v/v)PEG 200, 0.1 g/L Xylene cyanole, 0.1 g/L Bromophenol blue, make up in RO water to 100%); Coomassie blue stain (Gradipure™, Gradipore Limited). Note: contains methanol 6% Acetic Acid solution for de-stain.

Molecular weight markers (Recommended to store at −20° C.): SDS PAGE (e.g. Sigma wide range); native PAGE (e.g. Gradipore native marker); Western Blotting (e.g. color/ rainbow markers).

SDS PAGE with Non-reduced Samples

To prepare the samples obtained from the separation process for PAGE analysis, 2×SDS sample buffer was added to sample at a 1:1 ratio (usually 50 μL/50 μL) in the microtiter plate wells or 1.5 mL tubes. The samples were incubated for 5 minutes at approximately 100° C. Gel cassettes were clipped onto the gel support with wells facing in, and placed in the tank. If only running one gel on a support, a blank cassette or plastic plate was clipped onto the other side of the support.

Sufficient 1×SDS glycine running buffer was poured into the inner tank of the gel support to cover the sample wells. The outer tank was filled to a level approximately midway up the gel cassette. Using a transfer pipette, the sample wells were rinsed with the running buffer to remove air bubbles and to displace any storage buffer and residual polyacrylamide.

Wells were loaded with a minimum of 5 μL of marker and the prepared samples (maximum of 40 μL). After placing the lid on the tank and connecting leads to the power supply the gel was run at 150V for 90 minutes. The gels were removed from the tank as soon as possible after the completion of running, before staining or using for another procedure (e.g. Western blot).

Staining and De-staining of Gels

The gel cassette was opened to remove the gel, which was placed into a container or sealable plastic bag. The gel was thoroughly rinsed with tap water, and drained from the container. Coomassie blue stain (approximately 100 mL Gradipure™, Gradipore Limited, Australia)) was added and the container or bag sealed. Major bands were visible in 10 minutes but for maximum, intensity, stain overnight. To de-stain the gel, the stain was drained off from the container.

The container and gel were rinsed with tap water to remove residual stain. 6% acetic acid (approximately 100 mL) was poured into the container and sealed. The de-stain was left for as long as it takes to achieve the desired level of de-staining (usually 12 hours). Once at the desired level, the acetic acid was drained and the gel rinsed with tap water.

A time course of the starting material and final product were run on 4-20% SDS-PAGE igels™ (Gradipore Limited, Australia). The gels were then stained using Gradipure™ Coomassie blue stain (Gradipore Limited, Australia) and de-stained with 6% acetic acid.

Isoelectric Focusing (IEF)

IEF was used to determine isoelectric points of components to assist in devising electrophoresis separation conditions. Standard IEF methods were employed as set out below.

Reagents: Novex® IEF Gels were used for pI determination and confirmation of isoforms of purified products. Novex® IEF Gels are 5% polyacrylamide, non-denaturing, and do not contain urea. The pH 3-10 gels have a pI performance range of 3.5-8.5.

Recommended Buffers: pH 3-10 IEF Gels (Novex® IEF Sample Buffer, pH 3-10 (2×) 25 mL, Cat. No. LC5311; Novex® IEF Cathode Buffer, pH 3-10 (10×) 125 mL, Cat. No. LC5310; Novex® IEF Anode Buffer, (50×) 100 mL, Cat. No. LC5300); IEF Cathode Buffers (1× working solutions) were degassed for 10 minutes under vacuum or purged 1 minute with inert gas just before using.

Fixing Solution: 17.3 g Sulphosalicylic acid, 57.3 g TCA, D.I. water fill to 500 mL, IEF, pH 3-7 Catalog # LC5371 (2×), 2.0 mL 10×Cathode Buffer (3-7), 3.0 mL Glycerol, Distilled water to 10.0 mL, Cathode Buffer, Cat. # LC5370 (10×), 5.8 g Lysine (free base), Distilled Water to 100 mL, Anode Buffer, Cat. # LC5300 (50×), 4.7 g Phosphoric Acid (85%), Distilled Water to 100 mL. 1×anode buffer should be ˜pH 2.4. 1×cathode buffer should be ˜10.1.

Protocol: Sample was prepared by adding one part sample to one part Novex® IEF Sample Buffer (2×) and mixed well.

Novex® IEF Cathode Buffer (10×) was diluted 1:9 with deionized water before use and the IEF Cathode Buffer (1× working solutions) degassed for 10 minutes under vacuum, or purged 1 minute with nitrogen or helium gas just before using. The upper buffer chamber was filled with the appropriate amount of Cathode Buffer.

Novex® IEF Anode Buffer (50×) was diluted 1:49 with deionized water before use and the appropriate amount of Anode Buffer poured into the lower buffer chamber.

An appropriate volume of sample was loaded into the wells which have been filled with Novex® IEF Cathode Buffer.

The gel was run according to the following running conditions: 100V constant—1 hour, 200V constant—1 hour, 500V constant—30 minutes, The approximated current started at 5 mA/gel and ended at 6 mA/gel. The run time was approximately 2.5 hours.

After the run, the gel was removed from the cassette and fixed in the fixing solution (see above for recipe) for 30 minutes.

The gel was placed in stain (0.1% Coomassie R-250) and shaken for 5 minutes. The gel was de-stained with a 1× solution of de-stain or Novex® Gel-Clear™ de-stain until the desired clarity was achieved. All fixing, staining and de-staining was performed with gentle shaking.

### EXPERIMENTAL

Protein Extraction from a Milk Source

The following experiments established a method of using a membrane-based preparative electrophoresis system to separate or purify molecules based on size and charge. Extraction of spiked protein in milk was hampered by the colloidal nature of milk, which had the effect of fouling the separation membrane and inhibiting protein transfer. Full cream whole bovine milk (non-homogenized, non-pasteurized) spiked with albumin was used as the starting material for a separation run. The separation had to be stopped after half an hour as the milk coagulated in the stream 1 tubing. Analysis of the samples showed no protein transfer. Thus, neat whole milk could not typically be used efficiently as the start material in the separation system. In order to overcome the problem of milk composition, some of the fat globules and casein micelles were removed from the milk, while retaining the recovery and functionality of the soluble proteins (especially the target recombinant protein).

A similar experiment was conducted where α-1-PI spiked skim milk was centrifuged for 40 minutes at 500 g. The middle fraction, which was expected to contain less fat and casein, was used as the starting material. Again, acceptable protein transfer between stream 1 and stream 2 was not observed. After the electrophoresis run, a thick layer of coagulated milk material and fat was seen on the separation membrane, resulting in the relative absence of protein transfer to stream 2.

Protein Extraction from Simulated Bovine Transgenic Milk

A model system was used to simulate bovine transgenic milk. Recombinant milk is a proprietary material at present and difficult to obtain. The concentration of a recombinant protein in transgenic milk typically ranges from 1 to 65 g/L. The concentration depends on the particular recombinant protein and the species and lineage of the transgenic animals involved. To simulate transgenic milk, the milk or milk fractions were spiked with a known concentration of a specific human plasma protein, and various pre-treatment methods were then applied to this spiked milk. After pre-treatment, the resulting fat and casein micelle-depleted whey was processed by preparative electrophoresis. When skim milk was used as the starting material, most of the fat content of the milk had already been removed by initial dairy processing of the milk. Treatment to remove casein micelles, however, was still preferred to prevent or reduce membrane fouling during preparative electrophoresis processing.

Whole raw bovine milk was sourced from a dairy farm within close proximity to Gradipore Limited (Sydney, Australia). The milk was aliquoted and frozen until required.

Fibrinogen, albumin and alpha-1-proteinase inhibitor (α-1-PI) were the proteins chosen to spike the milk as these proteins are presently produced in transgenic milk. The concentrations of the spike were chosen according to the availability of the protein and the likely concentrations found in transgenic milk. Fibrinogen was initially made up at 10 mg/mL in phosphate buffered saline (PBS) allowing the fibrinogen to completely dissolve prior to addition to make a final concentration of 2 mg/mL. Albumin was spiked at 10 mg/mL and α-1-PI spiked at 2-3.5 mg/mL. Prolastin is a commercially available α-1-PI product, derived from human plasma.

Pre-treatment of Simulated Transgenic Milk

Milk Dilution

After spiking the milk with a specific protein, the milk was diluted about 1 in 40. This was found to be a good dilution at which the milk could be filtered through a 0.45 μm nitrocellulose filter via vacuum filtration. This filtered material was used as the starting material from which the spiked protein was purified using an electrophoresis apparatus. The spiked protein was at relatively low concentrations after the dilution and thus detection was more difficult.

Acid Precipitation

After spiking the milk with a specific protein (α-1-PI at 3 mg/mL or albumin at 10 mg/mL), the pH of the milk was adjusted from 6.7 to 4.6 to precipitate any casein present. The pH was adjusted by the use of either hydrochloric acid or sodium acetate. The pH of the whey was brought back up to pH 6.7 after filtering using the electrophoresis separation buffer. The activity of α-1-PI was restored after the pH was returned to pH 6.7.

Rennet Coagulation

After spiking the milk with a specific protein (human fibrinogen at 1-2 mg/mL), rennet was added to the milk at a final concentration of 0.1 mg/mL. The milk was then shaken for 2-3 minutes, and then left to stand for 2-3 hours at 37° C., during which time it was not disturbed to allow the milk to coagulate. The coagulate was then removed by centrifugation for 15 minutes at 3000 rpm. The coagulate was at the bottom and the whey fraction (with the soluble proteins including the spiked protein) was located on top of the coagulate with some fat globules present on the surface. The whey was then filtered (by vacuum filtration) through a 1 μm glass fiber filter membrane. The collected filtrate was then ready to undergo preparative electrophoresis.

Protein Separation from Simulated Transgenic Milk

All electrophoresis separations used limits of 250V, 1 Amp, 150 W. All separations were run in forward polarity with the cathode positioned above the sample stream (stream 1) where the pre-treated milk was applied, unless otherwise noted.

Unless stated otherwise, 0.1 M sodium acetate precipitation was used for pre-treatment of the albumin- and α-1-PI-spiked skim milk. Rennet coagulation was used for the pre-treatment of the fibrinogen-spiked skim milk. Acid precipitation is not advisable for fibrinogen-spiked milk as the fibrinogen can also co-precipitate. Furthermore, acid precipitation can have detrimental affects on the functional activity of fibrinogen causing inactivation.

Results for Protein Separation from Simulated Transgenic Milk

Albumin Separation

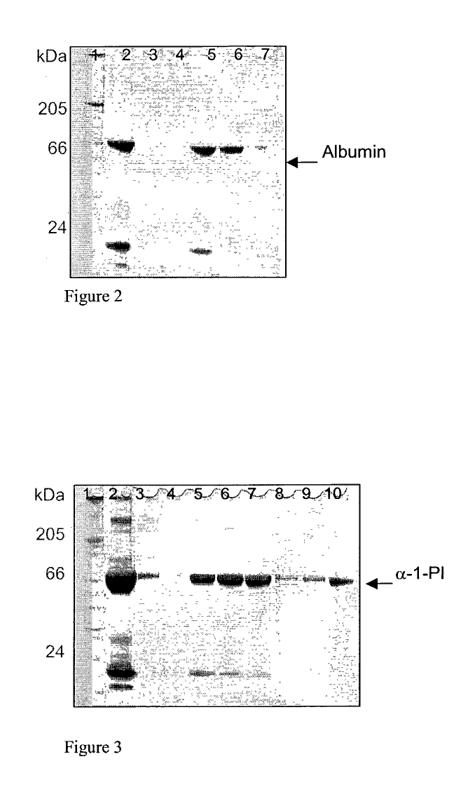

Albumin-spiked whey was separated through a 100 kDa separation membrane sandwiched between 5 kDa upper and lower restriction membranes of an electrophoresis apparatus. Tris borate buffer at pH 9.0 was used to transfer the albumin from stream 1 to stream 2 under electrophoretic conditions. High pH was used as the albumin was negatively charged and thus migrated towards the anode during electrophoresis. Stream 2 (containing the target component) was harvested half hourly over a three hour period. The polarity was reversed after every harvest for two minutes. The two minute reversal provided de-fouling of the membranes. Roughly one hundred percent of the albumin was transferred to stream 2 over the three hour period and was recovered. The first hour samples contained some low molecular weight contaminants. The high molecular weight milk contaminants remained in the stream 1. FIG. 2 shows the analysis of albumin purification/separation indicating successful separation of albumin from milk whey.

α-1-PI Separation

The α-1-PI spiked whey was separated through a 100 kDa separation membrane sandwiched between a 5 kDa upper restriction and a 15 kDa lower restriction membrane. The stream 2 was harvested hourly over a seven hour period (no harvest was taken at the 360 minute time point). In order to transfer the α-1-PI from stream 1 to stream 2 under electrophoretic conditions, HEPES/Imidazole buffer at pH 7.3 was used. At this pH, the α-1-PI was negatively charged and thus migrated towards the anode during electrophoresis. Some low molecular weight contaminants that were present in the albumin harvests were also present in the first harvest of for the α-1-PI separation. The high molecular weight whey proteins, however, remained in the stream 1 residual material.

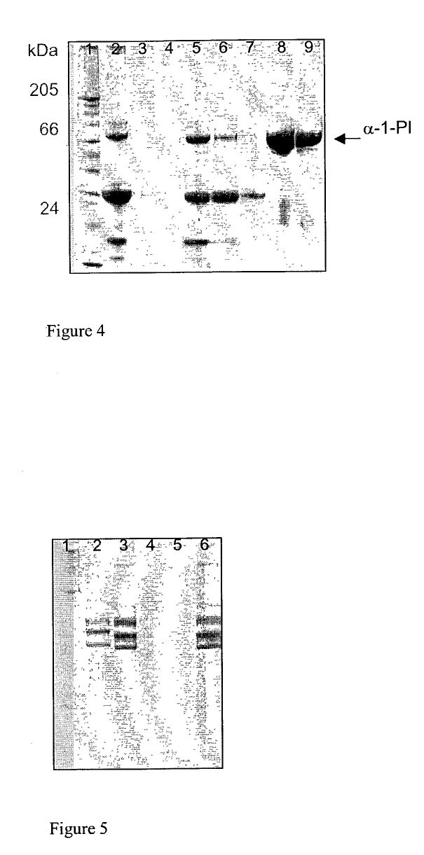

Whole milk was spiked with α-1-PI, diluted with water and then filtered. This filtered material was separated through a 100 kDa separation membrane sandwiched between 5 kDa upper and lower restriction membranes. The stream 2 was harvested every two hours over a six hour period. HEPES/Imidazole buffer at pH 7.3 was used to transfer the α-1-PI from the stream 1 to the stream 2 under electrophoretic conditions. Some low molecular weight contaminants were evident in the stream 2 harvests. This contamination can be eliminated by altering the membrane characteristics (i.e. increasing the pore size of the bottom restriction membrane) and altering buffers (i.e. dropping the pH of the buffer) used for the separation. After electrophoresis, the high molecular weight whey proteins remained in the stream 1 residual material. Protein transfer of 93% was also achieved for diluted whole milk spiked with α-1-PI. FIGS. 4 shows the analysis of α-1-PI purification from diluted milk.

Fibrinogen Separation

Whey that had been spiked with fibrinogen was separated through an 800 kDa separation membrane sandwiched between a 5 kDa upper restriction and a 50 kDa lower restriction membrane, as illustrated in FIG. 5. Stream 2 was harvested after three hours. Tris Borate buffer at pH 9.0 was used to transfer the fibrinogen from stream 1 to stream 2, as the fibrinogen was negatively charged under the buffer conditions and thus migrated towards the anode. Low molecular weight contaminants that passed through separation membrane into stream 2 were removed through the lower restriction membrane and into the buffer stream. Thus there were no low molecular weight contaminants detected in the harvests at the end of the separation period. Some high molecular weight contaminants also transferred with the fibrinogen to stream 2. This contamination can be eliminated by changing the membrane characteristics (i.e. increasing the size of the bottom restriction membrane) and altering buffers (i.e. lowering the pH of the buffer) used for the separation. A large amount of endo-osmosis (the movement of fluid from stream 2 to stream 1) was experienced during the fibrinogen separations. The volume of the stream 1 sample expanded considerably, causing a diluting out effect of the milk sample. The use of top restriction membranes composed of polyvinyl alcohol overcomes this endo-osmosis phenomenon by drawing excess fluid out of stream 1 back into the buffer stream, thereby preventing the increase in the volume of stream 1.

Other Pre-treatments Tested

Methanol and ethanol were tested singly or in combination with detergents (Tween™ 20, Tween™ 80, Triton™ X-100, CHAPS™, TNBP, and SDS) as a method for breaking up the casein micelles in milk. Milk that had been treated with alcohol and/or detergent was able to be filtered via vacuum filtration.

Comparison of Milk Pre-Treatment

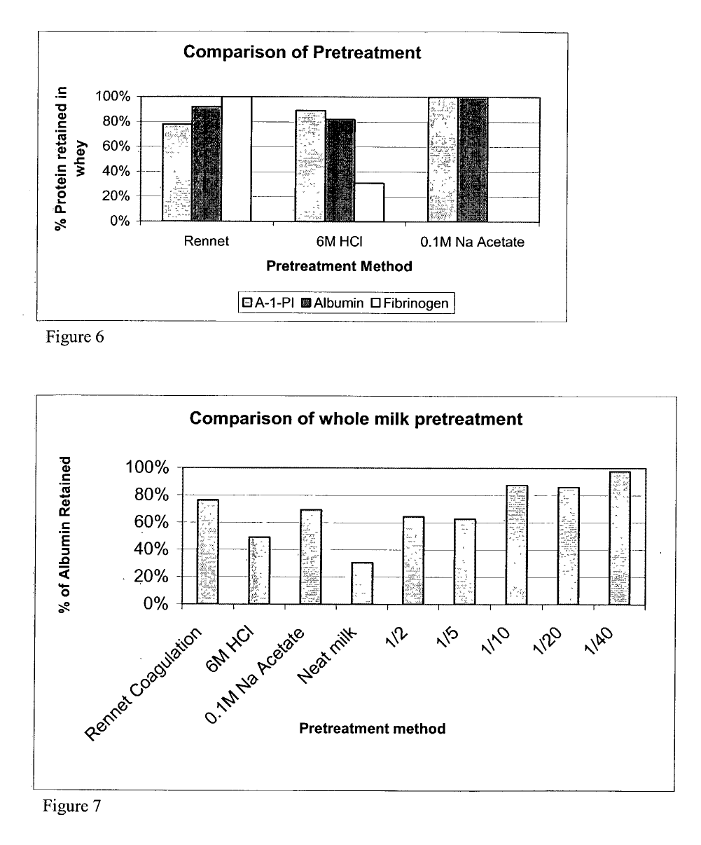

A comparison of the pre-treatments of the skim milk was conducted to assess which method retained the greatest amount of the spiked protein in the whey product. The results are presented in FIG. 6. With regard to α-1-PI-spiked skim milk, acetate treatment did not adversely affect the amount of α-1-PI present such that roughly all α-1-PI remained after treatment. Acid treatment (HCl) caused a loss of about 10% of α-1-PI whereas rennet treatment caused a loss of about 20%. With regard to albumin-spiked skim milk, acetate treatment did not adversely affect the amount of albumin present such that roughly all albumin remained after treatment. Acid treatment (HCl) caused a loss of about 20% of albumin whereas rennet treatment caused a loss of about 10%. With regard to fibrinogen-spiked skim milk, acid treatment (HCl) caused a loss of about 70% of fibrinogen whereas rennet treatment caused, no loss. Acetate treatment was not carried out on fibrinogen-spiked skim milk.

Different pre-treatments may have different effects on the amount of protein present. As a general rule, if the target protein is unaffected by acid, casein may be precipitated with sodium acetate, acetic acid or other acid conditions. If the target protein is acid labile, rennet or other non acidic means may be used to aggregate the casein.

Precipitation with 0.1 M sodium acetate was used for the pre-treatment of albumin- or α-1-PI-spiked skim milk. Rennet coagulation was used for the pre-treatment of fibrinogen-spiked skim milk.

A comparison of the pre-treatment of whole milk spiked with albumin was also carried out. The fat content of whole milk presented an additional factor. The same three pre-treatments that were carried out on the skim milk were carried out on the whole milk. An additional pre-treatment of diluting and filtering the milk was also assessed.

As illustrated in FIG. 7, rennet coagulation caused the loss of about 25% albumin, whereas filtering neat milk resulted in a 10% loss. Diluting milk by at least 1:10 followed by filtration resulted in less than 15% loss.

General Milk Characterisation by Membrane-Based Electrophoresis

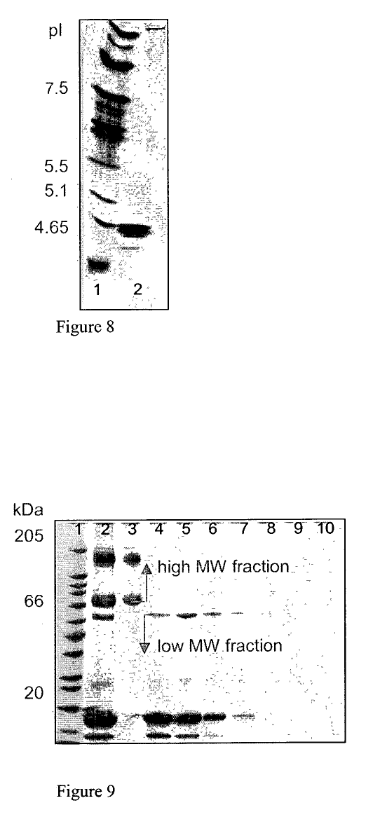

Skim milk/whey at pH 5.4+/−EDTA resulted in no protein movement observed during electrophoresis when the sample was placed in stream 1 under forward polarity. FIG. 8 shows all milk whey proteins migrating to a pI range of 4.8-5.1. The experimental pH of 5.4 does not provide the proteins with a reasonable charge-to-mass ratio, hence no movement under the described conditions.

Skim milk at pH 6-9 resulted in variable protein movement depending on pH. At the alkaline range, casein remained problematic for many separations. Because casein micelles are held together by a calcium ion interaction, the ability of EDTA (a calcium chelating agent) to disrupt casein micelles was also tested. Treatment of skim milk with EDTA solubilized casein micelles, decreasing the clogging of the membrane and permitting the transfer of other proteins. Movement of casein across large separation membranes was achieved. Depending on the dilution factor, however, complete removal of casein was typically not achieved.

Whey at pH 8.0 and 100 kDa membrane resulted in high/low molecular weight split which can be further processed. FIG. 9 depicts results of high and low molecular weight fractions of milk achieved with EDTA treatment.

Processing of High Molecular Weight Fraction from Whey

As discussed above, the processing of milk and whey at the acidic pH resulted in no significant protein transfer during electrophoresis. However, the processing of whey into high and low molecular weight fractions, produced fractions which are much less complex and therefore may be further processed at an acidic pH.

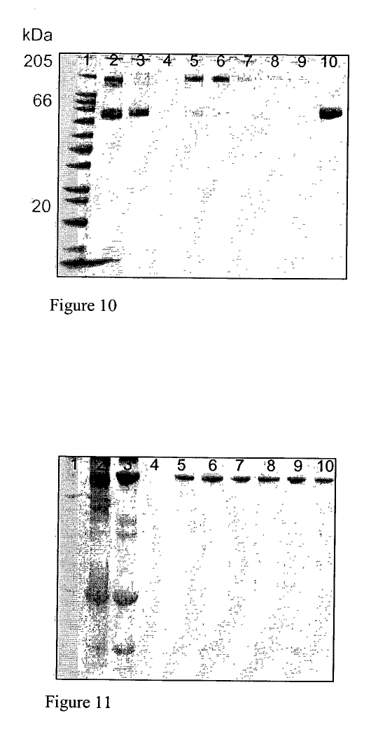

Results show that fractionating the high molecular weight fraction at pH 5.0 has been achieved as illustrated in FIG. 10.

Protein Extraction from Bovine Colostrum

Provided below is a summary of experimentation performed using membrane-based electrophoresis technology to purify proteins from fresh colostrum and a commercially available colostrum preparation Intact™ (Northfield Laboratories, Adelaide, Australia). Several initiatives taken to facilitate and optimize these purifications including pre-treatment of the starting material are also described.

Pre-treatment of Colostrum

Several methods were investigated to alter colostrum prior to processing in the electrophoresis apparatus. The aim of this was to avoid detrimental effects such as clogging which have in the past occurred with starting materials of similar nature (i.e. milk). The pre-treatment strategies aimed to fractionate the colostrum into three main components:

Fat

The fat component makes up approximately 3.5% of colostrum. Its presence is undesirable in regards to protein separations as it tends to foul membranes.

Casein

The second fraction is mostly composed of casein proteins. These proteins represent about 80% of the total protein content of colostrum and are mostly present as colloidal particles known as micelles. These micelles also cause membranes to block and large amounts of research has been conducted worldwide into their removal from milk-based materials.

Whey

The third fraction is referred to as whey. This water-based fraction contains the majority of the proteins of interest including the immunoglobulins.

Filtration

Twenty g of powdered Intact™ was dissolved in 100 mL of water to make a 20% (w/v) solution. An attempt was made to pass this solution through a 1 μm filter but no solution passed the filter. A 1/10 dilution of the above solution was made and was successfully passed through a 1 μm filter.

Incubation

Twenty g of powdered Intact™ was dissolved in 100 mL of water to make a 20% (w/v) solution. One solution was made by diluting 1:1 with pH 5.0 γ-amino butyric acid/acetic acid (GABA/AA) buffer, the other by diluting 1:1 with pH 5.5 GABA/AA buffer. These two 10% (w/v) solutions were incubated at room temperature (RT) for 2 hrs, and then at 37° C. for ˜14 hrs. No precipitation of solids (casein) took place in either solution at any stage.

Precipitation

Precipitation with Rennet. 20 g of powdered colostrum was dissolved in 100 mL of water. A 20 mL aliquot of this solution was mixed with 2 mg of rennet and let stand for 2 hrs at 37° C. The mixture was then centrifuged for 15 min at 3000 rpm. A fat layer formed on top of the solution and was removed. The whey layer was decanted and filtered through a 0.22 μm syringe filter with 7 mL of solution recovered.

Purification of IgG from a Commercially Available Colostrum Preparation

Filtered Colostrum Preparation @ pH 5.0

The following experiments established that IgG in a colostrum preparation was separated from stream 1 to stream 2 using a suitable electrophoresis apparatus.

Twenty grams of powdered colostrum was dissolved in 100 mL of water. This solution was diluted 1/10 and filtered through a 1 μm filter. Fifteen mL was used as starting material and was placed in stream 1 of a membrane-based electrophoresis apparatus.

Stream 2 contained 10 mL GABA/AA buffer pH 5.0. The buffer stream (BS) contained ˜1.8 L GABA/AA buffer pH 5.0. The cartridge configuration contained a 5-1000-5 kDa (restriction-separation-restriction) membrane configuration. The apparatus was run in reversed polarity for 150 minutes. Stream 2 was harvested.

SDS-PAGE analysis showed almost complete transfer of IgG proteins to stream 2. Upon inspection after the completion of the run the stream 1 cartridge cavity was clogged with solid material (appeared to be casein).

Rehydrated Colostrum at pH 5.4

This experiment established that the level of lower molecular weight (LMW) contaminants passing to stream 2 was reduced in reference to the above experiment.

Twenty grams of powdered colostrum was dissolved in 100 mL of water. Fifteen mL was used as start material and was placed in stream 1. Stream 2 contained 10 mL GABA/AA buffer pH 5.4. The buffer contained ˜1.8 L GABA/AA buffer pH 5.4. The cartridge was arranged in a 5-1000-5 kDa (restriction-separation-restriction) membrane configuration. The polarity was reversed and the apparatus was run for 270 minutes with harvesting of stream 2 every 30 minutes.

SDS-PAGE analysis showed incomplete transfer of IgG to stream 2. The level of LMW contaminants was slightly reduced from the previous run. Upon inspection after the completion of the run the stream 1 cartridge cavity was clogged with solid material (appeared to be casein).

Rehydrated Colostrum at pH 5.0 Using Selective Membranes

The following experiment established the transfer of IgG to stream 2 while retaining higher molecular weight (HMW) proteins in stream 1 and allowing LMW proteins to pass into the buffer stream via the second restriction membrane of the membrane-based electrophoresis apparatus.

Twenty grams of powdered colostrum was dissolved in 100 mL of water. Fifteen mL was used as starting material and was placed in stream 1. Stream 2 contained 10 mL GABA/AA buffer pH 5.0. The buffer stream contained ˜1.8 L GABA/AA buffer pH 5.0. The cartridge was configured at 10-900-80 kDa (restriction-separation-restriction) membrane configuration. Polarity was reversed and the apparatus run for 180 minutes with harvesting of stream 2 every 30 minutes.

SDS-PAGE analysis showed incomplete transfer of IgG to the stream 2. The level of LMW contaminants was slightly reduced from the previous run with a prominent band of protein in the range of 20-50 kDa visible. Upon inspection after the completion of the run the stream 1 cartridge cavity was clogged with solid material.

Rehydrated Colostrum at pH 5.0 with a Larger Pore Size Second Restriction Membrane

The following experiment established that the level of LMW contamination in the IgG sample was reduced.

Twenty gram of powdered colostrum was dissolved in 100 mL of water. Fifteen mL of this solution was diluted in 30 mL of GABA/AA buffer pH 5.0 and was placed in stream 1. Stream 2 contained 10 mL GABA/AA buffer pH 5.0. The buffer stream contained ˜1.8 L GABA/AA buffer pH 5.0. The cartridge configuration was 5-900-80 kDa (restriction-separation-restriction) membrane configuration and the polarity reversed. The apparatus was run for 270 minutes with harvesting of stream 2 every 30 minutes.

SDS-PAGE analysis showed a significant level of transfer of IgG to the stream 2. The level of LMW contaminants was reduced significantly from the previous run with only a light protein band in the range of 20-50 kDa visible. Upon inspection after the completion of the run the stream 1 cartridge cavity contained some solid material although the level was less than in previous runs. After a run time of 60 minutes, the colostrum solution in the stream 1 reservoir was separating into three layers or ‘fractions’. At the termination of the run, stream 1 was collected and centrifuged for a period of 15 minutes at 3000 rpm. The result was three very distinct layers (solids on bottom, whey in middle, fat on top). This result was similar to what is usually seen after acid treatment of milk, and similar to the desired outcome of a pre-treatment step.

Rehydrated Colostrum at pH 5.0 with a Larger Pore Size Second Restriction Membrane

The following experiment established that the level of LMW contamination in the IgG sample was reduced.

Twenty grams of powdered colostrum was dissolved in 100 mL of water. Fifteen mL of this solution was diluted in 30 mL of GABA/AA buffer pH 5.0 and was placed in stream 1. Stream 2 contained 10 mL GABA/AA buffer pH 5.0. The buffer stream (BS) contained ˜1.8 L GABA/AA buffer pH 5.0. The cartridge configuration was 10-900-100 kDa (restriction-separation-restriction) membrane configuration and the polarity reversed. The apparatus was run for 180 minutes with harvesting of stream 2 every 30 minutes.

SDS-PAGE analysis (FIG. 11) showed a significant level of transfer of IgG to the stream 2 with no significant contamination. Upon inspection of the cartridge after the completion of the experiment, the stream 1 cavity contained very little solid material although the level was less than in previous runs. This experiment established a method of purification of IgG from colbstrum.

These experiments resulted in the development of a protocol to purify IgG from a bovine colostrum preparation using membrane-based electrophoresis technology. In doing so it also displayed the general principle of purification of bovine proteins from colostrum using this technology. The ‘fractionation’ effect in stream 1 indicated a potential use of the technology to separate the whey out of colostrum, both in-line and as a dedicated process.

Initiatives to Facilitate Purification of Colostrum Proteins Using Electrophoresis Technology

During the development of an IgG purification protocol several strategies were attempted to improve the efficiency of the separations. The major focus of this work was to reduce clogging in the stream 1 cartridge cavity. Initial results from the IgG purification experiments indicated that casein was accumulating in this space resulting in reduced flow and clogging of the membrane. Areas of solids were shown to be ‘cooked’ onto the membrane, which indicated possible lack of effective flow with concomitant increase in temperature. The following experiments illustrates strategies that overcame these difficulties.

Structural Modification of the Stream 1 Cartridge Grid

This experiment established that the amount of solids were reduced in the stream 1 cartridge cavity by removing a mesh support in the stream 1 grid component of the separation cartridge of the apparatus.

The mesh support was removed from a conventional grid using a scalpel. This new ‘open grid’ was used in the stream 1 of the cartridge. A standard run was then carried out. However, the removal of the grid mesh had no effect on the amount of clogging with this concentration of start material. Later runs performed using a 1:3 dilution of Intact™ showed the removal of the grid mesh significantly reduced the level of clogging in the stream 1 cartridge space.

Colostrum Characterization During Membrane-based Electrophoresis

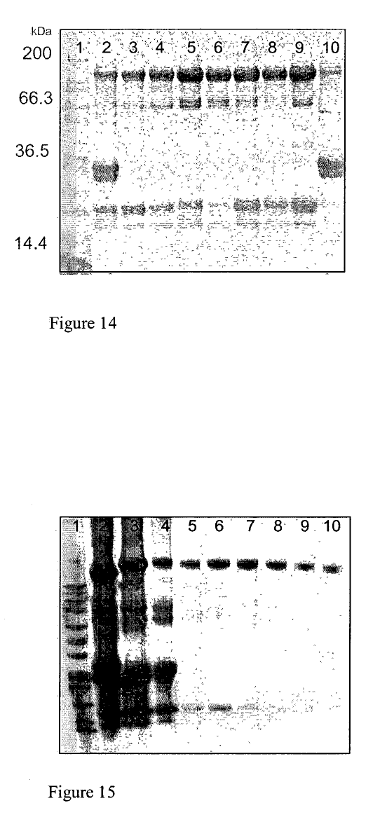

In contrast to milk, proteins in colostrum do transfer during electrophoresis in the acidic pH range. The pre-treatment of colostrum with EDTA improved the purity of the IgG fraction with the results illustrated in FIG. 14 and FIG. 15.

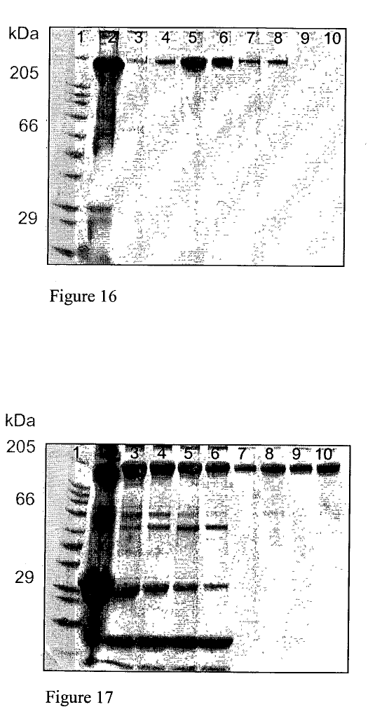

In addition to skim colostrum, experiments on IgG isolation from colostrum whey were conducted. EDTA pre-treatment was used even though casein had been removed. by rennet precipitation and centrifugation. The results confirmed that either the dilution factor (from addition of EDTA solution) or the EDTA had a positive effect on reducing protein interactions in the source material, hence, improving the purification, as seen in FIG. 16.

Purification of IgG from Fresh Colostrum

In addition to the commercially available colostrum preparation, a series of experiments was conducted using fresh colostrum and fresh colostrum whey.

Colostrum Characterization During Membrane-based Electrophoresis

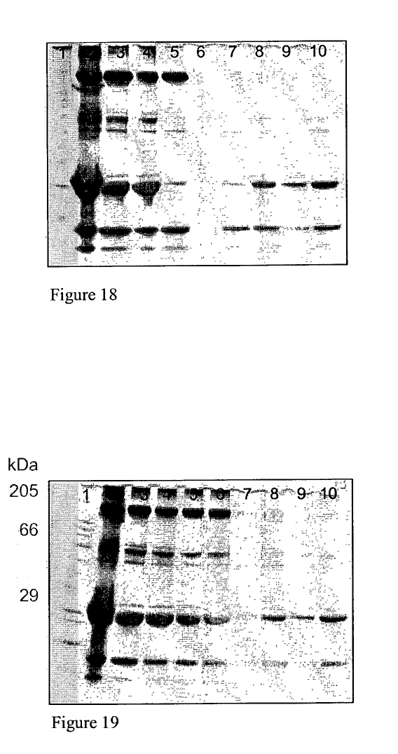

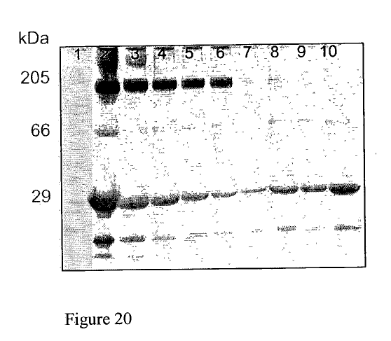

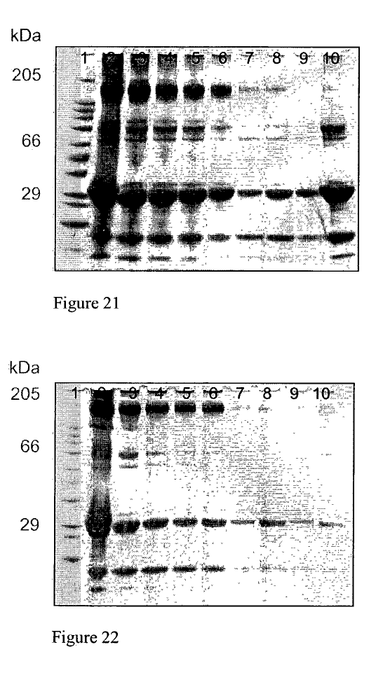

A profile of protein movement in skim colostrum was achieved in a suitable electrophoresis unit. A pH range of 5.0-10.0 and using a 1000 kDa separation membrane provided valuable information on colostrum behavior in the electrophoresis unit. FIGS. 17-22 illustrate the SDS-PAGE protein profile for the experiments.

As seen from the results of these experiments, IgG movement was reduced at pH 6.0 and above. As the pH rises from 5.0-10.0, the protein profile of the harvest stream changes.

Purification of IgG on a Large Scale

The following experiment demonstrates the capacity to generate milk/colostrum components in commercial quantities, and to produce an IgG enriched product in large scale. A process volume of 1.2 L of colostrum whey was used at pH 4.7 using 1000 kDa separation membranes. FIG. 23 illustrates the SDS-PAGE protein profile for the experiment.

As can be seen from the results of these experiments, an IgG enriched fraction was produced in two hours with the major contaminant being lactoglobulin. Optimization of this protocol enhances IgG purity and allows for the production of a commercial IgG product at commercial scale.

Membrane Integrity Test

As milk sources are not conventionally considered as material for processing by membrane-based electrophoresis, the following tests demonstrated the integrity and functionality of the membranes after exposure to milk sources.

Ten separation cycles were conducted each day for 5 consecutive days on a laboratory-sized electrophoresis instrument. At the completion of each day, a cleaning cycle was conducted followed by an exchange of the experimental buffer. The cartridge was stored in the fresh buffer in the instrument overnight at room temperature until experimentation the following day.

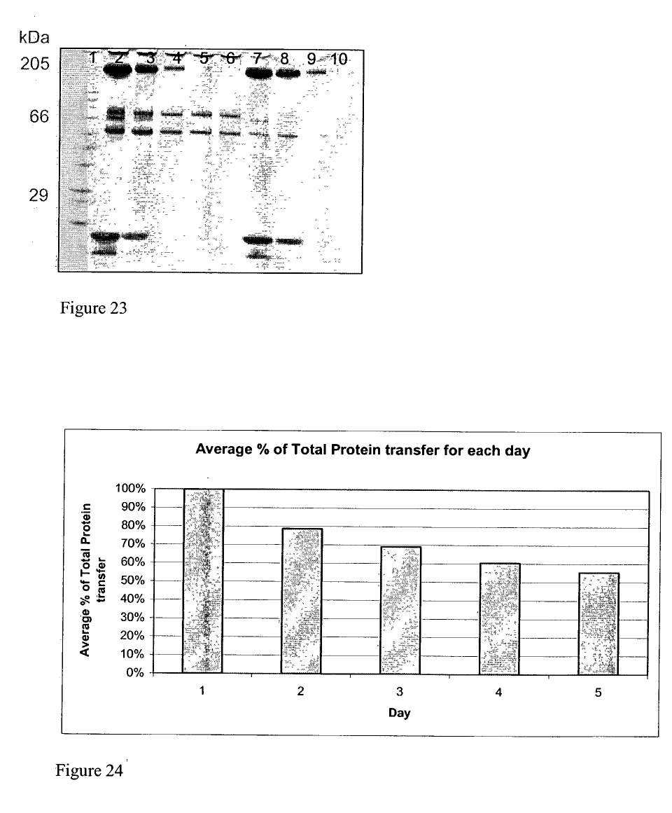

FIG. 24 shows the average total protein transfer across the separation membrane for 50 non-consecutive hours of processing colostrum whey. At the fifth day (50 hours) the membranes reached their half life in performance under the chosen conditions. No failure of the integrity was observed in any of the membranes tested.

The total protein and SDS-PAGE analysis revealed that protein was still being transferred after 50 hours. Protein transfer showed a clear trend, by increasing after the use of fresh experimental buffer, followed by a decrease over time. This relationship was consistent on each day. The average protein transfer decreased each successive day of membrane use but the system still functioned without membrane failure.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art or were common general knowledge in the field as it existed before the priority date of each claim of this application.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. A method for obtaining a target component from a milk source, comprising:
(a) pre-treating the milk source to remove or reduce the concentration of one or more fats, casein or proteins;
(b) placing the pre-treated milk source in an interstitial volume of an electrophoresis apparatus comprising a first restriction membrane disposed between a first electrode zone and a separation membrane so as to define a first interstitial volume therebetween, and a second restriction membrane disposed between a second electrode zone and the separation membrane so as to define a second interstitial volume therebetween;
(c) selecting a solvent such that the target component in the pre-treated milk source has a desired charge state;
(d) applying an electric potential between the first and second interstitial volumes whereby at least a portion of the target component is located on one side of the separation membrane while unwanted molecules are located on the other side of the separation membrane; and
(e) maintaining step (d) until the desired amount of target component is located on one side of the separation membrane.

2. A method for obtaining a target component from a milk source, comprising:
(a) pre-treating the milk source to remove or reduce the concentration of one or more fats, casein or proteins;
(b) placing the pre-treated milk source in a first interstitial volume of an electrophoresis apparatus comprising a first restriction membrane disposed between a first electrode zone and a separation membrane so as to define a first interstitial volume therebetween, and a second restriction membrane disposed between a second electrode zone and the separation membrane so as to define a second interstitial volume therebetween;
(c) selecting a solvent for the first interstitial volume having a pH such that the target component in the pre-treated milk source has a desired charge state;
(d) applying an electric potential between the first and second interstitial volumes whereby at least a portion of the target component in the first interstitial volume moves through the separation membrane into the second interstitial volume while unwanted molecules in the pre-treated milk source are prevented from entering the second interstitial volume; and
(e) maintaining step (d) until the desired amount of component is moved to the second interstitial volume.

3. A method for separating toxin, pathogen or infectious agent contamination from a target component from a milk source, comprising:
(a) pre-treating the milk source to remove or reduce the concentration of one or more fats, casein, or proteins;
(b) placing the pre-treated milk source in a first interstitial volume of an electrophoresis apparatus comprising a first restriction membrane disposed between a first electrode zone and a separation membrane so as to define a first interstitial volume therebetween, and a second restriction membrane disposed between a second electrode zone and the separation membrane so as to define a second interstitial volume therebetween;
(c) selecting a solvent for the first interstitial volume having a pH such that the target component in the pre-treated milk source has a desired charge state;
(d) applying an electric potential between the first and second interstitial volumes whereby at least a portion of the target component in the first interstitial volume moves through the separation membrane into the second interstitial volume while unwanted molecules, toxin, pathogen or infectious agent contaminants are prevented from entering the second interstitial volume; and
(e) maintaining step (d) until the desired amount of the target component is moved to the second interstitial volume.

4. The method according to claim 1, 2 or 3 further comprising stopping the electric potential whereby an unwanted molecule having entered the separation membrane moves back into the sample in the first interstitial volume while not allowing the target component that has passed into the second interstitial volume to re-enter the first interstitial volume.

5. The method according to claim 1, 2 or 3 further comprising reversing the electric potential whereby an unwanted molecule having entered the separation membrane moves back into the sample in the first interstitial volume while not allowing the target component that has passed into the second interstitial volume to re-enter the first interstitial volume.

6. The method according to claim 1, 2 or 3 wherein the milk source is selected from the group consisting of milk, milk component, whey, casein, colostrum, a fraction thereof, and mixtures thereof.

7. The method according to claim 6 wherein the milk source is from a normal animal, a hyperimmunised animal, a transgenic animal, or genetically altered animal that has been genetically altered to express one or more recombinant proteins or peptides in its milk.

8. The method according to claim 1, 2 or 3 wherein the component is from a normal animal, a hyperimmunised animal, a transgenic animal, or genetically altered animal that has been genetically altered to express one or more recombinant proteins or peptides in its milk.

9. The method according to claim 3 wherein the toxin, pathogen or infectious agent is selected from the group consisting of endotoxin, prion, virus, bacteria, fungus, yeast or protozoa.

10. The method according to claim 9 wherein contaminating virus or bacteria are separated from the target component.

11. The method according to claim 1, 2 or 3 wherein the target component from the milk source is selected from the group consisting of protein, peptide, antibody, lactalbumin, lactoglobulin, immunoglobulin, growth factor, fibrinogen, albumin, insulin, recombinant forms thereof, and mixtures thereof.

12. The method according to claim 11 whereby the immunoglobulin is immunoglobulin G.

13. The method according to claim 1, 2 or 3 whereby pre-treating step (a) involves undergoing a dilution

14. The method according to claim 1, 2 or 3 whereby pre-treating step (a) involves undergoing a centrifugation step.

15. The method according to claim 1, 2 or 3 whereby pre-treating step (a) involves undergoing a precipitation step.

16. The method according to claim 1, 2 or 3 whereby pre-treating step (a) involves undergoing a filtration step.

17. The method according to claim 1, 2 or 3 whereby pre-treating step (a) involves undergoing a de-fatting step.

18. The method according to claim 1, 2 or 3 whereby pre-treating step (a) involves undergoing adding a detergent.

19. The method according to claim 1, 2 or 3 whereby pre-treating step (a) involves undergoing a chelation step.

20. The method according to claim 19 whereby the chelation step involves ethylene diaminetetraacetic acid (EDTA).

21. The method according to claim 1, 2 or 3 whereby pre-treating step (a) involves adding a fat-disrupting agent.

22. The method according to claim 1, 2 or 3 whereby pre-treating step (a) involves undergoing an acidification step.

23. The method according to claim 22 whereby the acidification step involves hydrochloric acid or acetate.

24. The method according to claim 1, 2 or 3 whereby pre-treating step (a) involves undergoing a coagulation step.

25. The method according to claim 24 whereby the coagulation step involves rennet (chymosin), another fat-separating process, or combinations thereof.

26. The method according to claim 1, 2 or 3 wherein pre-treating step (a) involves undergoing a protein denaturing agent addition.

27. The method according to claim 1, 2 or 3 wherein pre-treating step (a) involves undergoing an enzymatic breakdown step.

28. The method according to claim 1, 2 or 3 wherein pre-treating step (a) involves undergoing a hydrolysis step.

29. A target component obtained from a milk source using the method according to claim 1, 2 or 3.

30. A target component separated from toxin, pathogen or infectious agent obtained from the method according to claim 3.

31. An electrophoresis apparatus for obtaining a target component from a milk source, comprising:
(a) a first restriction membrane disposed between a first electrode zone and a separation membrane so as to define a first interstitial volume therebetween;
(b) a second restriction membrane disposed between a second electrode zone and the separation membrane so as to define a second interstitial volume therebetween; and
(c) a transporter connected to at least one of the first or second interstitial volumes, wherein a milk source reduced in fat, casein, or protein is transported to at least one of the first or second interstitial volumes.

32. The apparatus according to claim 31 further comprising a heat removing arrangement.

33. The apparatus according to claim 32 wherein the heat removing arrangement is a heat exchanger.

34. The apparatus according to claim 31 wherein the transporter comprises a settling reservoir for containing a milk sample, the reservoir having an inlet connected to the first or second interstitial volumes, and an outlet connected to the first or second interstitial volumes, wherein the inlet is positioned to transport pre-treated milk source from the reservoir to an interstitial volume, whereas fats and solids in the milk sample remain in the reservoir.

35. The apparatus according to claim 34 wherein the settling reservoir comprises an upper reservoir and a lower reservoir, the upper and lower reservoirs being in fluid communication and separated by a series of graduated steps capable of retaining solid material therein but allowing fluid to flow from the upper reservoir to the lower reservoir, the outlet being positioned in the upper reservoir and the inlet being positioned in the lower reservoir.
